(19) United States
(12) Patent Application Publication
(10) Pub. No.: US 2005/0043970 A1
(43) Pub. Date: Feb. 24, 2005

(54) Electronic imaging dental record management system

(76) Inventor: Kent Hsieh, Chupei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/644,836

(22) Filed: Aug. 21, 2003

(51) Int. Cl. G06K 9/54; G06F 17/60; G06K 9/60

(52) U.S. Cl. 705/3; 382/305

(57) ABSTRACT

A computerized electronic dental record management system that allows dentists to quickly and easily view and analyze patient's dental conditions and clearly explain and show their diagnosis to the patients. The dentist uses a flexible thin camera to take photographs or images of the teeth. These images are stored in a patient's electronic dental record. At any time, the dentist can use these images to analyze or diagnose the patient's condition and formulate a treatment plan. The dentist can also use these images to clearly show and explain the patient's condition and proposed treatment plan to the patient. Additionally, using a hand-held monitor, the patient can also view the images in real time as the dentist is inspecting the patient's teeth.

### BACKGROUND OF THE INVENTION

1. Field of the Invention

The present invention relates to an electronic image database. More specifically, the present invention discloses a computerized electronic dental record management system that allows dentists to capture electronic images of a patient's teeth in order to quickly and easily view and analyze the patient's dental condition and clearly explain and show their diagnosis to the patients.

2. Description of the Prior Art

Originally, the earliest studies in medical information and application system of modern medicine were in the 1970's. The main area of interest was in the information management of clinical experiences of medical services.

In the 1990's, managed healthcare was proposed in some countries, in order to effectively control the appropriation of medical insurance in social welfare and modernize the medical management system.

However, there are numerous kinds of medical information, and the information management of various subjects/categories is also different. For example, some systems are in charge of patient registration, hospitalization data, charges, administrative finance and equipment. The appointments, methods of diagnosis and reports for radiology are managed by another system. Another system is in charge of the stored images, managed and diagnosed records created by X-ray, CT, MR, SPECT and Ultrasound.

However, the structure and functions of the present medical information systems cannot satisfy the need of clinical diagnosis and treatment. Particularly the value of medical imaging information has not yet realized.

Additionally, the various systems mentioned above were not developed in the same period of time, so the structures and standards are different. They are not compatible and cannot share information.

Furthermore, the target market of these information systems is for medical personnel and not for patient's diagnosis.

In the dental field, patients cannot fully understand the condition of their bad teeth and only hear the dentist's analysis. When a patient is on the diagnosis platform, dentist use a mirror as a reflector placed in the patient's mouth to diagnose. When necessary, patients try to hold a mirror to see the condition of their teeth. Usually, this is futile as the mirror, dentist's fingers, dental tools, etc. obstruct the tiny mirror that is already positioned at an awkward angle. Therefore, patients typically do not have a very clear understanding of the condition of their teeth.

As a result, patients usually must take the dentist's word for their condition and blindly accept the dentist's diagnosis and treatment plan.

Therefore, there is a need for an efficient system for capturing electronic images of a patient's dental condition and for storing and creating a patient's dental record history that allows dentists to conveniently and effectively diagnosing and explaining the patient's condition to the patient.

### SUMMARY OF THE INVENTION

To achieve these and other advantages and in order to overcome the disadvantages of the conventional method in accordance with the purpose of the invention as embodied and broadly described herein, the present invention provides a computerized electronic dental record management system that allows dentists to quickly and easily view and analyze patient's dental condition and clearly explain and show their diagnosis to the patients.

The present invention comprises a computerized administrative system and an electronic imaging device for dental medical records. The oral imaging computerized administrative system further comprises software and a computer. Accessories comprise an intra-oral camera, an adaptor, a hand-held monitor and a desktop monitor.

As a dentist is inspecting a patient's teeth, the dentist uses a flexible thin camera to take photographs or images of the teeth. These images are stored in a patient's electronic dental record. At any time, the dentist can use these images to analyze or diagnose the patient's condition and formulate a treatment plan. The dentist can also use these images to clearly show and explain the patient's condition and proposed treatment plan to the patient. Additionally, using a hand-held monitor, the patient can also view the images in real time as the dentist is inspecting the patient's teeth.

The computerized electronic dental record management system provides numerous advantages, such as:

Dentists can take pictures from different angles in a patient's mouth with a long and thin camera.

When a dentist is using the camera and his hands are both occupied, he can press a pedal with his foot in order to take pictures.

It allows patients to see the detailed images that the doctor has taken of their condition. Additionally, when the doctor is diagnosing or taking pictures, the patient can easily see the pictures using a hand-held monitor.

During diagnosis, the doctor or nurse can input the results into the computer at any time.

It can record patient's records directly.

It provides horizontal or vertical side-by-side analysis of different patients' records.

Patient can see the dental image at the workstation, and listen to the doctor's diagnosis, in order to understand their own dental situation.

The dental clinic can efficiently process cross-platform operations, broadcasting, and transfer of the dental records electronically.

An object of the present invention is to provide an electronic dental record management system, which allows patients to view a hand-held monitor replacing the traditional mirror. In this way, patients can easily find a suitable angle according to the tooth that the dentist is explaining the condition of.

An object of the present invention is to provide an electronic dental record management system that provides dentists establish dental imaging records of patients. It is not only convenient for repeat visits or historical documentation, but dentists can also make horizontal and vertical analysis of multiple images of patient's conditions.

Another object of the present invention is to provide an electronic dental record management system whereby the established medical records can be used as medical insurance proof and if necessary be used as police or justice evidence.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating a computerized electronic dental record management system according to an embodiment of the present invention;

FIG. 2 is a diagram illustrating a hand-held monitor according to an embodiment of the present invention;

FIG. 3, is a diagram illustrating a computerized electronic dental record management system utilizing multiple computers according to an embodiment of the present invention;

FIG. 4A is a flowchart illustrating options for basic information of the computerized electronic dental record management system according to an embodiment of the present invention;

FIG. 4B is a drawing illustrating options for a basic information of the computerized electronic dental record management system according to an embodiment of the present invention;

FIG. 5A is a flowchart illustrating options for a personal dental record of the computerized electronic dental record management system according to an embodiment of the present invention;

FIG. 5B is a drawing illustrating options for a personal dental record of the computerized electronic dental record management system according to an embodiment of the present invention;

FIG. 5C is a drawing illustrating options for a personal dental record of the computerized electronic dental record management system according to an embodiment of the present invention;

FIG. 5D is a drawing illustrating options for a personal dental record of the computerized electronic dental record management system according to an embodiment of the present invention;

FIG. 6A is a flowchart illustrating system manager options of the computerized electronic dental record management system according to an embodiment of the present invention;

FIG. 6B is a drawing illustrating system manager options of the computerized electronic dental record management system according to an embodiment of the present invention;

FIG. 6C is a drawing illustrating system manager options of the computerized electronic dental record management system according to an embodiment of the present invention;

FIG. 7A is a flowchart illustrating system manager options of the computerized electronic dental record management system according to an embodiment of the present invention; and

FIG. 7B is a drawing illustrating system manager options of the computerized electronic dental record management system according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The electronic dental record management system of the present invention comprises a camera, an input device, a server and a diagnostic workstation. The camera or photographic appliance comprises an oral camera and an X-ray machine. The input device comprises a registry device and a medical record input device. The server comprises medical record images, a dental imaging database, and an administrative system safety device, as well as applicable software and a computer.

The dental imaging database comprises imaging dental records of registered patients and domestic and foreign medical records of special cases. The administrative system safety device comprises a user's authorization system, an input device and a firewall. The workstation comprises traditional dental tools and a diagnosis platform. The workstation further comprises an adaptor, a hand-held monitor, an input device and a monitor, an input support and a desktop monitor. The adaptor provides dentists a pedal with an on/ off switch to transfer the images to the computer as well as the hand-held monitor that a patient can hold, in order to give patients a better understanding of their dental situation. The computer monitor is for displaying images of medical records.

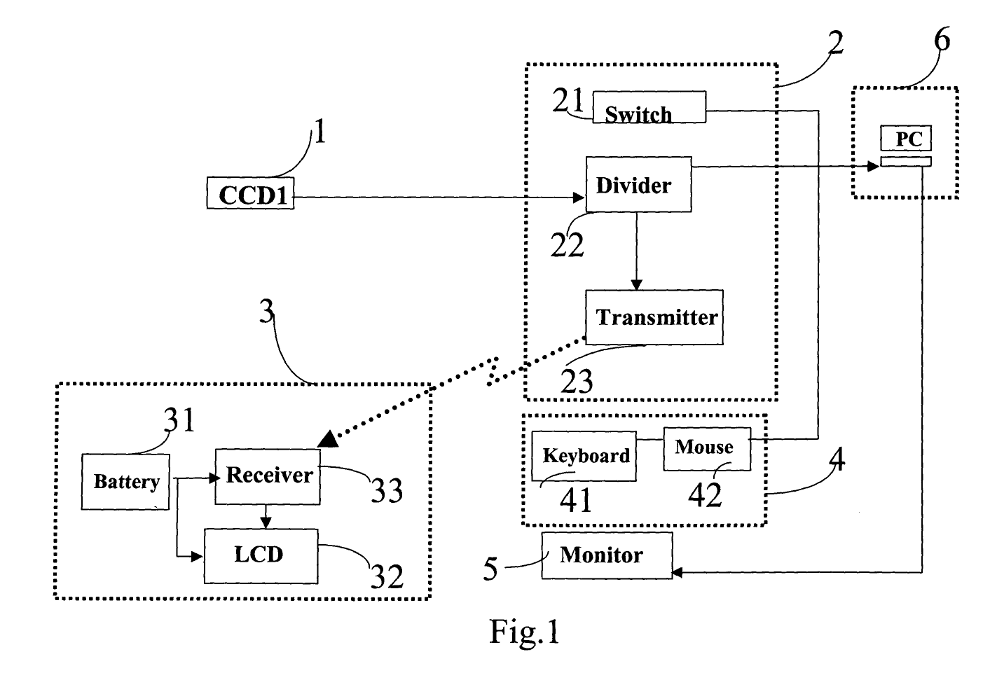

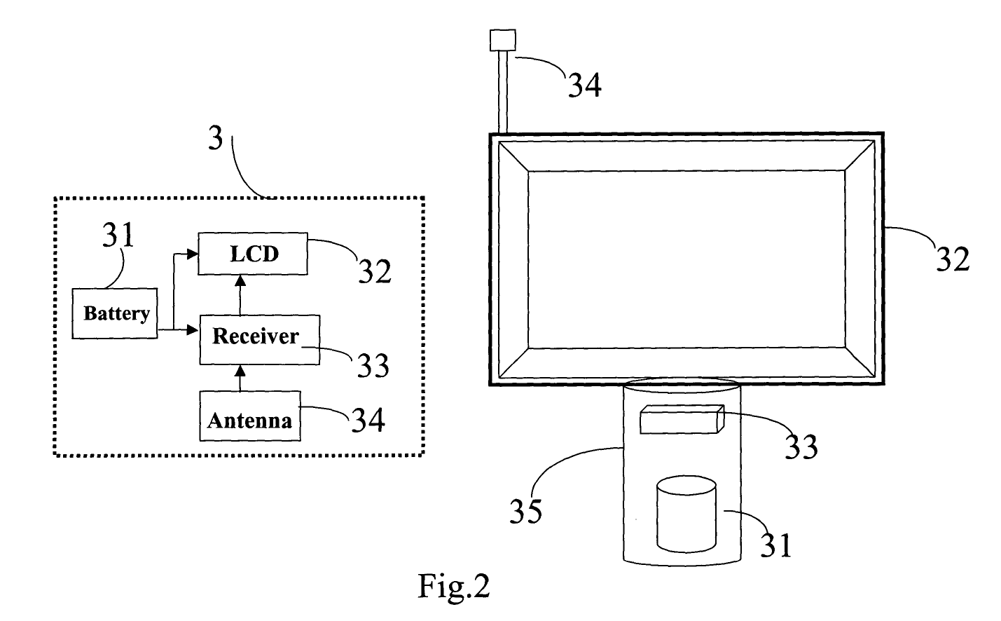

Refer to FIG. 1, which is a diagram illustrating a computerized electronic dental record management system according to an embodiment of the present invention and FIG. 2, which is a diagram illustrating the hand-held monitor according to an embodiment of the present invention.

The electronic dental record management system comprises photographic equipment 1, input devices 4, a computer 6 and diagnostic workstation.

The photographic equipment comprises an intra-oral camera 1 and a dental X-ray camera. The intra-oral camera 1 is used to take pictures of the exterior of a tooth. When necessary, a dentist uses the X-ray camera to take pictures of the interior of a tooth. The photographed images are then transferred to the medical record of images server, in order to facilitate explanations to patients, future tracking or storing medical records.

The input devices 4 comprise a keyboard 41 and a mouse 42 for recording a patient's initial and subsequent appointments and personal data; and a medical record input device which records the diagnosis text and newly photographed images.

The computer 6 comprises a medical image record server, a database of dental images and security system management as well as applicable software

The basic functions of the software are to accept a patient's personal data, comprising a registration number, time of appointment and photograph, and store new photographs or pictures with the patient's personal data, indicate the storage space left on the hard-drive, recognize and input authorization levels, maintain a modifiable and printable medical history, and display images for horizontal and vertical side-by-side analysis.

Another component is the database of dental images. The database stores all the patients' medical records, including the diagnostic summary and the related images for the dentist or dental clinic. For large hospitals, the database also stores dental images of special domestic and foreign cases as reference.

Another component is a network security or safety device. As well as new technology, many local clinics and hospitals have a network such as LAN or WAN and Internet access. The security device protects the management system from network vulnerabilities such as unauthorized access.

During use, a patient sits on the diagnosis work-platform. The dentist verifies the patient's personal photographic from the medical image records on the top left hand corner of the monitor 5 on the side of the work-platform and then checks out the patient's medical records and history. By verifying the patient's identity, potential insurance fraud can be avoided.

The dentist uses a mouse 42 of the input device 4 to scroll through and check the pages of the stored dental images. When necessary, the desired images can be dragged into the display frame, or a full screen enlarged image can be displayed. After reviewing the information, the dentist picks up the intra-oral camera 1, and covers the camera 1 with a single-use disposable transparent soft cover, in order to prevent transmission of possible infections after being used by numerous patients.

Since it is difficult to find the correct angle on both sides of a cavity, the dentist uses one hand to hold the handle of the intra-oral camera 1 and uses the other hand to adjust the tip of the intra-oral camera 1, in order to find the correct angle. An advantage of the present invention is that the tip of the camera is flexible and jointed so that the camera can be positioned at a convenient angle from the handle of the camera.

Then, the dentist presses the foot pedal or switch 21 to take a picture. The picture is transferred through the splitter or divider 22 in the adaptor 2 to the computer 6, in order to store and display the images on the monitor 5. These images can then be used as reference for medical insurance uses and compensation.

If the patient cannot see the images directly from the monitor, he can use the hand-held monitor 3 instead. The image divider 22 can transfer the dental images to a radio transmitter 23 in the adaptor 2. This allows the images to be viewed in a remote location by a receiver within the transmission field. The hand-held monitor 3 in the patient's hand provides a monitor means for image display instead of a mirror. The traditional way for most dentists is to use a mirror for patient to see the image reflected from the mirror. Since the mirror is outside of the mouth, there are surely some dead angles. However, using the intra-oral camera placed in a patient's mouth to take pictures, and then transfer the images to the hand-held monitor can solve the dead angle problem.

The hand-held monitor 3 comprises an LCD screen 32 and a handle 31. There is a battery power supply 31 in the handle 35 and an image radio receiver 33. When the battery 31 power is turned on, the built-in radio image receiver 33 receives images from the radio image electronic transmitter 23 in the adaptor 2. The image is displayed on the LCD screen 32 of the hand-held monitor 3. Patients can see the images displayed on the monitor in their hand, in order to avoid dead angles. In some embodiments of the present invention, there is a button to adjust the brightness, contrast and saturation and the angle of the antenna 34 can also be adjusted.

After diagnosis, the dentist uses the keyboard 41 of the input device 4 to input new information into the medical records database. In order to supply insurance firms or police justice, the medical image record database is designed to be unchangeable. However, in other embodiments the records can be modified as required.

When diagnosis is finished, the patient can ask the dentist to print out the dental images to take home as a warning or reminder. Additionally the dentist can use the images taken from the intra-oral camera or images on the hard-drive connected via TCP/IP to a server for remote teaching or appointment with patients, or under the patient's authorization, the record can also be displayed on the Internet or shared with other dental professionals.

Followings are two examples in different environments using a computer.

The first example uses only one computer but allows multiple users to use the present invention. Interface cards such as an image capture card, image divider card, signal control card, keyboard divide card and mouse card, are installed in the computer. The interface card in this example is a 4 port I\O, which can receive inputs from 4 intra-oral cameras, 4 monitors, 4 pedal switches and 4 mice. In this example, the interfaces can be used by 4 dentists at a time. Each dentist has an intra-oral camera to take pictures and diagnose, a monitor to display images on the computer, a pedal to take pictures, a keyboard to input data, and a mouse to choose images from the database. This example is more suitable for small clinics or dentist offices.

The second example uses multiple computers. The computer comprises several compact computers or thin clients (TC) and a main PC. In this example, there is a thin client on each dentist's work-platform. The TC has no hard-drive. Many TC's can be connected to one main PC as computer server. As long as it is within the server's capacity, more TC's can be added accordingly. This example is more suitable for Dental Hospitals.

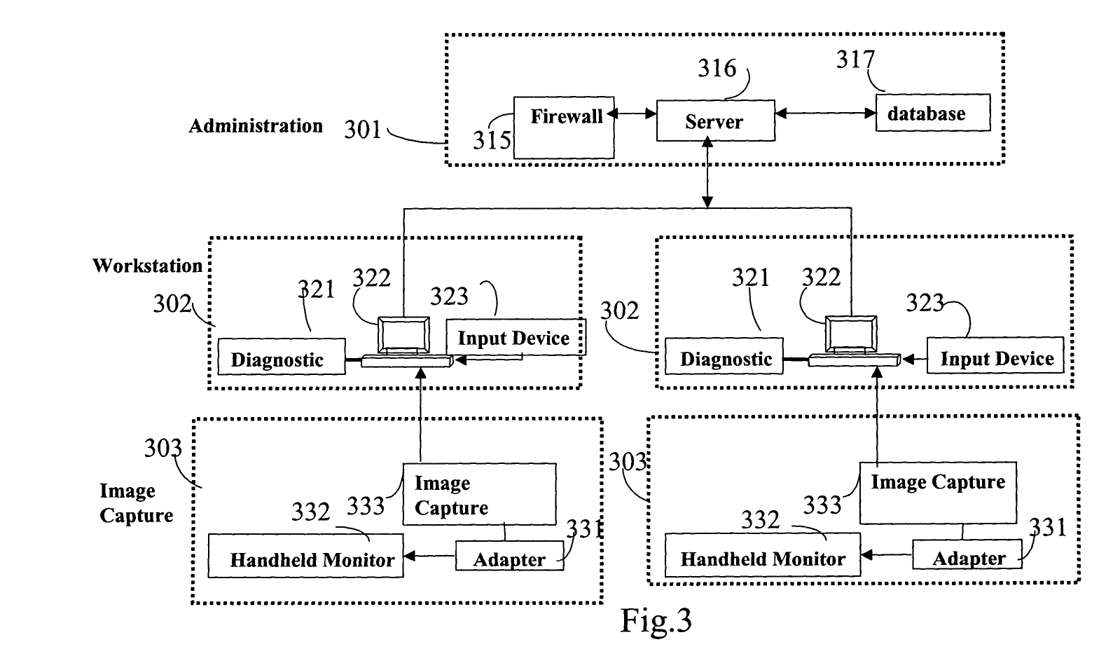

Refer to FIG. 3, which is a diagram illustrating a computerized electronic dental record management system utilizing multiple computers according to an embodiment of the present invention.

The administration section 301 comprises a firewall 315 for preventing unauthorized access, a server and modem 316, and the patient dental record database 317.

Each dentist's workstation 302 comprises a diagnosis workstation 321, a computer 322, and an input device 323.

The image processing unit 303 comprises an image capture device 333, such as a dental camera, an adapter 331, and a hand-held monitor 332.

The dentist uses the image capture device 333 to take a picture. The image is then transmitted to the computer 322 and to the hand-held monitor 332 via the adapter 331.

Each workstation 302 is connected to the server and modem 316.

In this way, multiple dentists are connected to a main administration server where the database is maintained. This is particularly useful for conveniently sharing data between dentists or offices that are remotely located. Additionally, this type of system is much more convenient to maintain by the administrator.

Following is a detailed description of the software flow and software options of the system of the present invention.

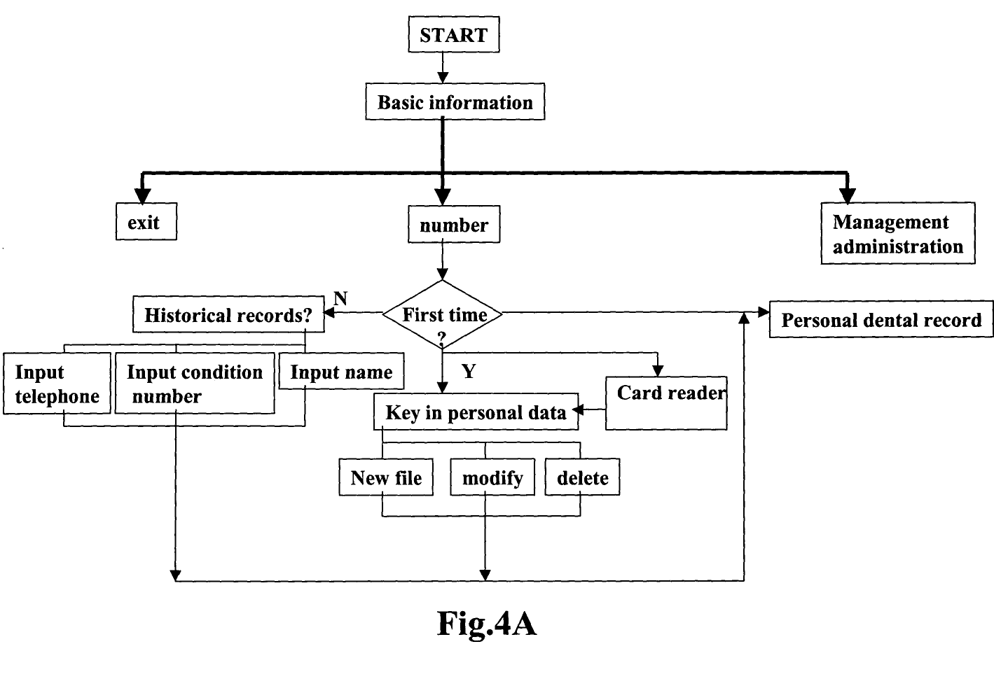

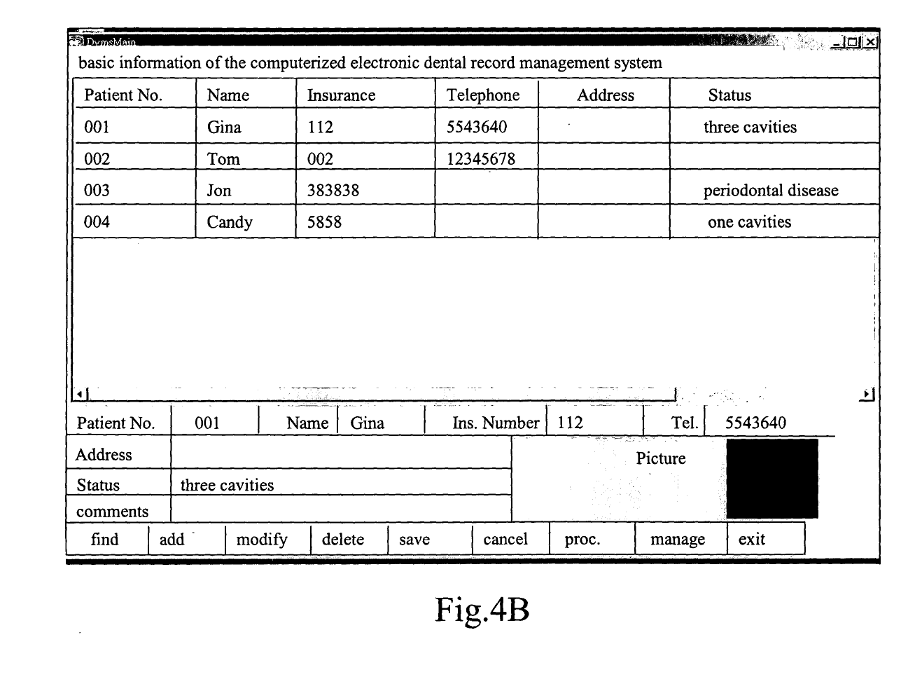

Refer to FIG. 4A, which is a flowchart illustrating options for a basic information of the computerized electronic dental record management system according to an embodiment of the present invention and FIG. 4B, which is a drawing illustrating options for a basic information of the computerized electronic dental record management system according to an embodiment of the present invention.

When the software program is launched, the user is greeted with a logon screen requesting the user's name and password. This acts as a deterrent to unauthorized access to the database and software.

After successfully logging in, the user is presented with the basic information screen. This screen shows a list of patients who have dental records stored in the database.

If the patient's number or code is known, it is entered in order to access their records. If not, it can be searched for by inputting the patient's telephone number, the condition number, the name of the patient, etc. Alternatively, the user can scroll through the list of patients in order to find the correct patient.

If it is the patient's initial visit to the clinic, a new record can be created. In an embodiment of the present invention, the patient's previous dental record is stored on a memory card or other removable storage medium so they can take it to the new dentist or clinic. In this embodiment, the record is read from the storage and is added to the database.

Alternatively, the patient's personal information and data are input and a new personal dental record file is created.

The personal information can be updated or modified in order to reflect any changes to the patient's info.

Additionally, a photograph of the patient is added to the file, so that anytime the record is accessed, a photograph of the patient is displayed. This can be used to verify the identity of the patient.

After the file is saved, the user can proceed to other menus such as image processing and system management.

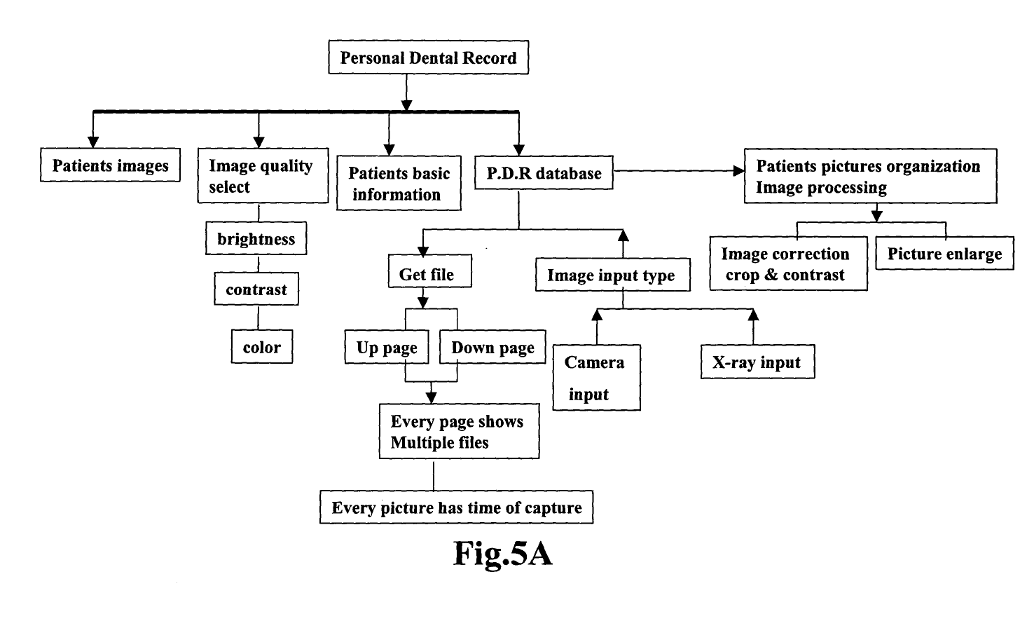

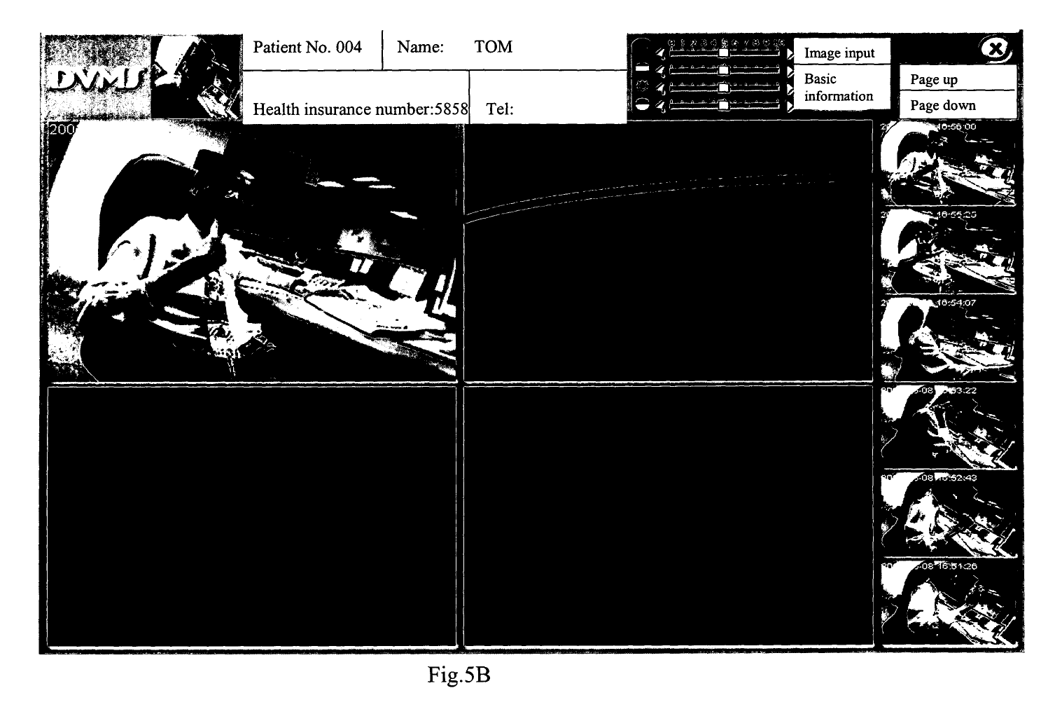

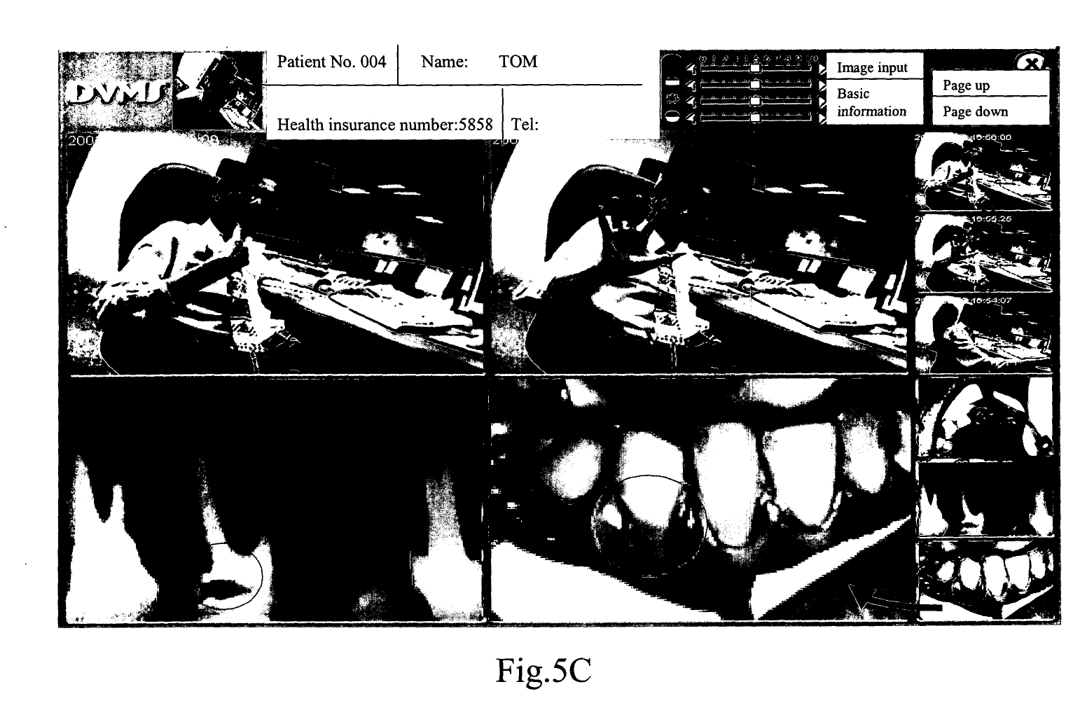

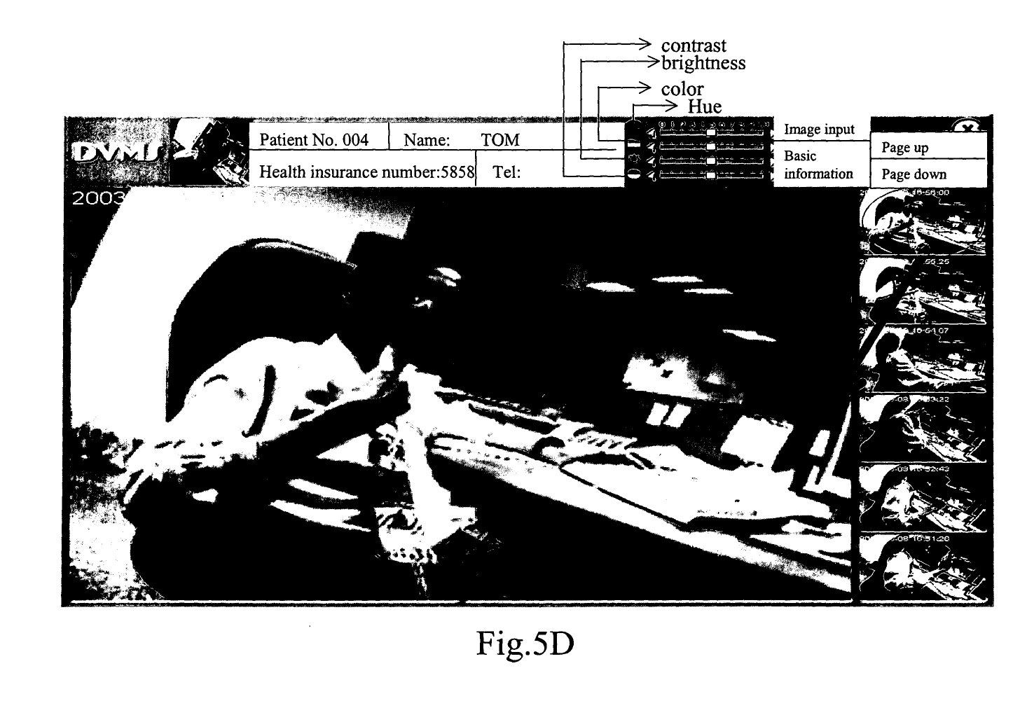

Refer to FIG. 5A, which is a flowchart illustrating options for a personal dental record of the computerized electronic dental record management system according to an embodiment of the present invention and to FIGS. 5B, 5C, and 5D, which are drawings illustrating options for a personal dental record of the computerized electronic dental record management system according to an embodiment of the present invention.

Upon entering the patient's personal dental record, the user is presented with a scrollable list of image thumbnails that are in the patient's dental record. In the figures, these thumbnails are shown vertically on the right side. These thumbnails can be scrolled through one at a time, or up and down by pages of, for example 6 or 8 images at a time.

When the desired image is located, the user simply drags it over to the main viewing area. In the figures, four images may be viewed in the main viewing area. However, this can be modified depending upon the image size. For example, a single full screen image is displayed by simply double-clicking on the image. To return to the regular 4-pane view, the image is again double-clicked.

The quality or image properties of each image can be modified using the sliders at the top of the figure. These properties are, for example, brightness, contrast, color, saturation, and grayscale.

Also, an advantage of the present invention is that each image is watermarked or stamped with the date and time of when the image was taken. This allows for ease in locating historical data.

Additionally, basic patient information is displayed on the top of the screen along with the patient's photograph.

On this page, the camera input can also be selected as well as options for image processing such as image enlargement, cropping, and correction.

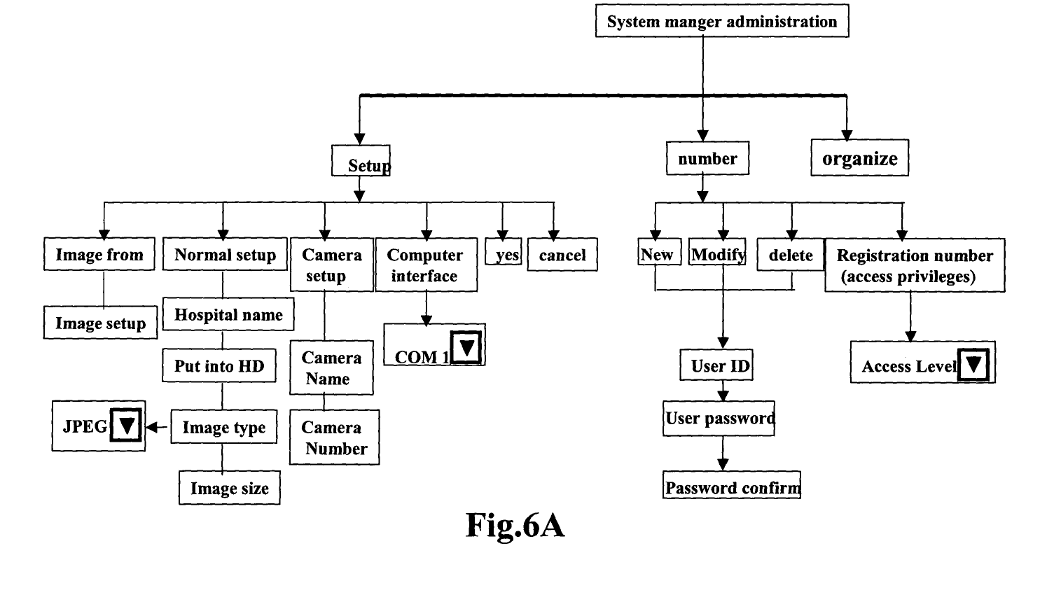

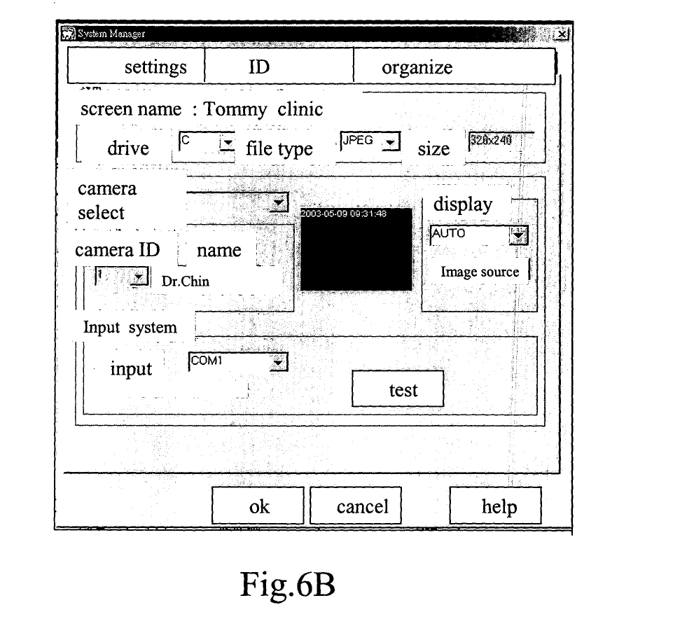

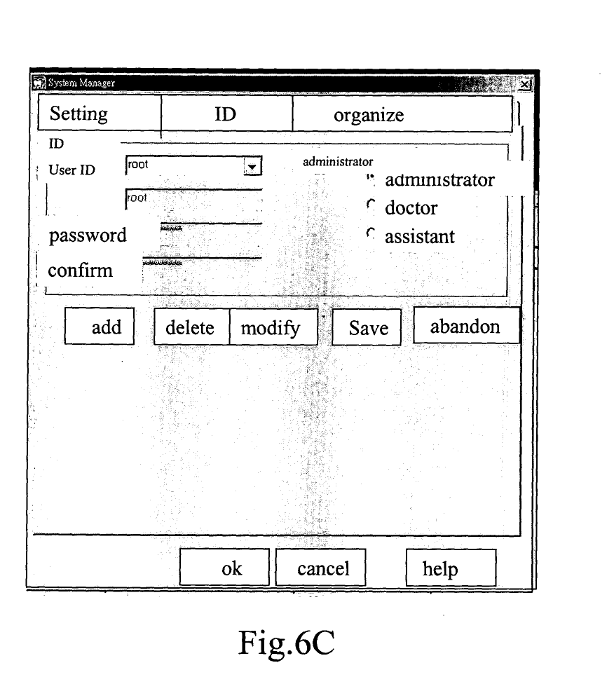

Refer to FIG. 6A, which is a flowchart illustrating system manager options of the computerized electronic dental record management system according to an embodiment of the present invention and to FIGS. 6B and 6C, which are drawings illustrating system manager options of the computerized electronic dental record management system according to an embodiment of the present invention.

In order to setup or make changes to the setup of the system, the user accesses the system manager.

On the settings tab, the dentist's name or clinic name can be setup for display on the login screen. Additional items for setup are which drive to store the images, file type, image size, camera selection, camera ID and name, camera input port (for example, Com1, Com2, USB, etc). In addition, the camera and input port can be tested by pressing the test button.

On the ID tab, the user ID and user password can be setup. Also, the access or privilege rights are setup, for example, administrator, doctor, or assistant. These settings may be added, deleted, or modified by clicking the appropriate button.

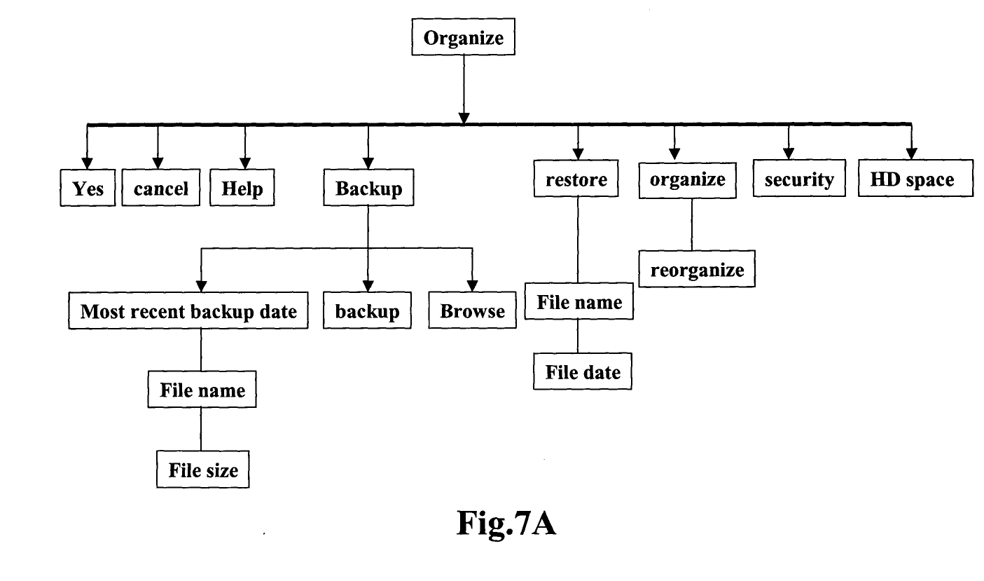

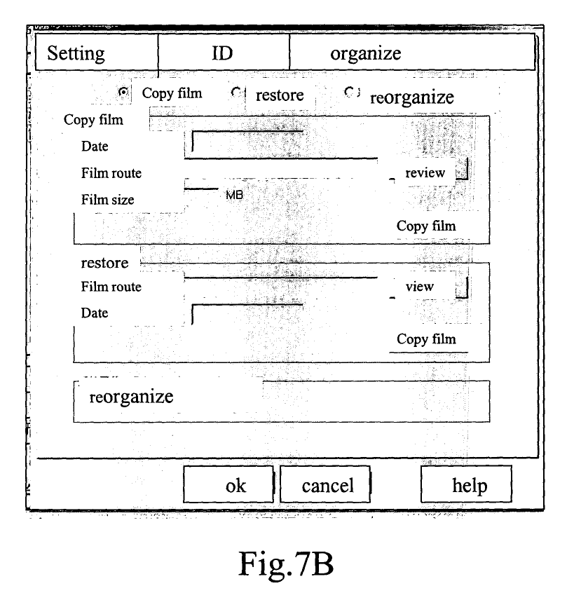

Refer to FIG. 7A, which is a flowchart illustrating system manager options of the computerized electronic dental record management system according to an embodiment of the present invention and to FIG. 7B, which is a drawing illustrating system manager options of the computerized electronic dental record management system according to an embodiment of the present invention.

Along with the setup and ID tabs in the system manager, the user has the option to access the organize tab. Various organizing options are available, such as backup database, restore database, or organize database.

Depending on the option selected, the most recent backup filename is automatically displayed. If a different file is desired, the file may be searched for using the browse button. The file size will then be displayed showing how large the file is. The database is backed up by pressing the backup button.

Similarly, the restore or organize functions are used by providing the correct database file name.

Additionally, the remaining hard drive space is shown so that low disk space can be avoided.

Further options are available, such as printing, whereby the dentist can print the patient's dental record.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

For example, while the above description details use in the dental field, the A computerized electronic record management system is also used in the fields of dermatology, proctology, gynaecology, or internal medicine.

1. A computerized electronic dental record management system comprising:
a camera for capturing images of a patient's teeth;
a computer for storing the captured images and inputting patient data; and
a database for organizing and managing the captured images and patient data into an electronic dental record.

2. The computerized electronic dental record management system of claim 1, whereby the patient data comprises, registration, cancellation, appointment, and contact information.

3. The computerized electronic dental record management system of claim 2, whereby the patient data further comprises, identification card number, driver's license number, and social security number.

4. The computerized electronic dental record management system of claim 2, whereby the patient data is stored on a memory card, smart card, or any integrated circuit card that has an integrated circuit board.

5. The computerized electronic dental record management system of claim 1, whereby the electronic dental record comprises a patient's photograph, patient's data, and a catalog of the patient's captured images.

6. The computerized electronic dental record management system of claim 1, whereby the database comprises database searching, image input, and processing of medical images.

7. The computerized electronic dental record management system of claim 6, whereby the image input allows an X-ray input as well as the camera input.

8. The computerized electronic dental record management system of claim 6, whereby the database further comprises reference images.

9. The computerized electronic dental record management system of claim 1, whereby the camera is a miniature camera with a movable head comprising a head, a handle and a joint connecting the head and handle so that the head can move in relation to the handle.

10. The computerized electronic dental record management system of claim 9, whereby the head comprises a camera and a light source for illumination.

11. The computerized electronic dental record management system of claim 10, whereby the handle for medical personnel to grip comprises a camera circuit control and a camera on/off switch.

12. The computerized electronic dental record management system of claim 11, further comprising a light source on/off switch.

13. The computerized electronic dental record management system of claim 1, further comprising a soft transparent plastic cover for covering the camera for hygiene reasons.

14. The computerized electronic dental record management system of claim 1, further comprising:
a network connection means for providing access to the database via the Internet, local area network and wide area network; and
a network security means for preventing unauthorized access to the database.

15. The computerized electronic dental record management system of claim 1, whereby the database provides direct recording of patient's personal data; displaying patient's registration number, diagnosis time, image capture time and date and medical records and images; displaying remaining storage space, recognition, user authorization, non changeable and printable medical records, and displaying medical records horizontally of different patients and vertically of same patient but at a different time.

16. The computerized electronic dental record management system of claim 1, further comprising:
a hand-held monitor for the patient to view images from the camera during diagnosis; and
an adaptor for connecting the camera to the hand-held monitor.

17. The computerized electronic dental record management system of claim 17, whereby the adaptor comprises a radio transmitter for transmitting to a radio receiver in the hand-held monitor or other image receivers.

18. The computerized electronic dental record management system of claim 1, further comprising a foot switch for triggering capture of the image.

19. A computerized electronic record management system comprising:
a camera for capturing images of a patient;
a computer for storing the captured images and inputting patient data; and
a database for organizing and managing the captured images and patient data into an electronic medical record.

20. A computerized electronic record management system whereby, the electronic medical record is a record of dental, tooth, oral, skin, dermatological, proctological, gynaecological, or internal medicine conditions.
